(19) United States
(12) Patent Application Publication
(10) Pub. No.: US 2023/0361402 A1
(43) Pub. Date: Nov. 9, 2023

(54) BATTERY MODULE AND BATTERY PACK INCLUDING THE SAME

(71) Applicant: LG Energy Solution, Ltd., Seoul (KR)

(72) Inventors: So Jeong Lee, Daejeon (KR); Jaehyun You, Daejeon (KR); Young In Kim, Daejeon (KR); Nam In Kim, Daejeon (KR); Jongha Jeong, Daejeon (KR)

(21) Appl. No.: 18/029,372

(22) PCT Filed: Jan. 7, 2022
(86) PCT No.: PCT/KR2022/000266

§ 371 Date: Mar. 29, 2023

(30) Foreign Application Priority Data
Jan. 22, 2021 (KR) 10-2021-0009540

(51) Int. Cl. H01M 50/204; H01M 50/507

(52) U.S. Cl. CPC H01M 50/204; H01M 50/507

(57) ABSTRACT

A battery module including: a battery cell stack including at least one battery cell; a bus bar frame covering the upper surface of the battery cell stack and the side on which a lead of the battery cell is protruding; a housing for accommodating a coupled body of the battery cell stack and the bus bar frame; and a pair of end plates coupled to the surface where the lead of the battery cell is disposed at both ends of the housing. A plurality of gas inducing holes are formed in at least one of an upper frame of the bus bar frame, an upper surface of the housing, and the end plate.

### CROSS-REFERENCE TO RELATED APPLICATIONS

This application is a US national phase of international application No. PCT/KR2022/000266 filed on Jan. 7, 2022, and claims the benefit of Korean Patent Application No. 10-2021-0009540 filed on Jan. 22, 2021, the disclosures of which are incorporated herein by reference in their entirety.

### TECHNICAL FIELD

The present invention relates to a battery module and a battery pack including the same, and more specifically, to a battery module capable of inducing and observing a gas flow inside the battery module, and a battery pack including the same.

### BACKGROUND

In modern society, as the use of portable devices such as mobile phones, notebook computers, camcorders, and digital cameras has become commonplace, the development of technologies related to the mobile devices has increased. Further, a rechargeable secondary battery is a measure to solve the air pollution of existing gasoline vehicles that use fossil fuels, and is used as a power source of an Electric Vehicle (EV), a Hybrid Electric Vehicle (HEV), a Plug-in Hybrid Electric Vehicle (P-HEV), and the like, and the need for development of the secondary battery is also increasing.

Currently commercialized secondary batteries include nickel cadmium batteries, nickel hydride batteries, nickel zinc batteries, lithium secondary batteries, and the like. Among them, the lithium secondary battery is in the spotlight for its advantages in that charge and discharge are freely performed because a memory effect is small, a self-discharge rate is very low, and energy density is very high, compared to the nickel-based secondary battery.

The lithium secondary battery mainly uses a lithium-based oxide and a carbon material as a positive electrode active material and a negative electrode active material, respectively. The lithium secondary battery includes an electrode assembly in which a positive electrode plate and a negative electrode plate, to which the positive electrode active material and the negative electrode active material are applied, respectively, are disposed with a separator interposed therebetween, and a battery case that seals and accommodates the electrode assembly together with an electrolyte.

In general, the lithium secondary battery may be classified as a can-type secondary battery in which the electrode assembly is embedded in a metal can, and a pouch-type secondary battery in which the electrode assembly is embedded in a pouch of an aluminum laminate sheet, according to a shape of the exterior material.

In the case of the secondary batteries used in small devices, two or three battery cells are disposed, but in the case of the secondary batteries used in medium and large devices, such as automobiles, a battery module in which the plurality of battery cells are electrically connected is used. In the battery module, the plurality of battery cells are connected to each other in series or in parallel to form a battery cell stack, so that capacity and output are increased. Further, one or more battery modules may be mounted together with various control and protection systems, such as a Battery Management System (BMS) and a cooling system, to form a battery pack.

On the other hand, the battery module may include a housing to protect the battery cell stack from external impact, heat, or vibration. The front and rear surfaces of the housing are open and form an inner space for accommodating the battery cell stack and a pair of end plates cover the front and rear surfaces of the housing.

FIG. 1 is an illustration of a conventional battery module.

As shown in FIG. 1, a conventional battery module 10 is configured to accommodate a battery cell stack in a space surrounded by a housing 20 and an end plate 30. In this configuration, it is difficult to detect ignition inside the battery module until a flame is transmitted to the outside or an explosion occurs because there is no means to visually monitor the battery cell stack from the outside. In addition, there is a problem in that it is difficult to present an appropriate solution by investigating an ignition when the ignition occurs because it is impossible to directly observe the heat transfer process from the inside.

### SUMMARY

Embodiments of the present invention to be proposed to solve the problems as described above are to provide a battery module capable of inducing a gas flow inside the battery module in a specific direction and observing the gas flow.

However, the problem to be solved in the embodiments of the present invention is not limited to the foregoing problem, and may be variously extended in the scope of the technical spirit included in the present invention.

A battery module according to an embodiment of the present invention includes: a battery cell stack including at least one battery cell; a bus bar frame covering the upper surface of the battery cell stack and the side on which the lead of the battery cell protrudes; a housing for accommodating a coupled body of the battery cell stack and the bus bar frame; and a pair of end plates coupled to the surface where the lead of the battery cell is disposed at both ends of the housing, wherein a plurality of gas inducing holes are formed in at least one of an upper frame of the bus bar frame, an upper surface of the housing, and the end plate.

The plurality of gas inducing holes may be formed in the upper surface of the housing.

The plurality of gas inducing holes may be arranged to form a plurality of columns along the length direction of the upper surface of the battery cell stack.

At least one of a plurality of columns may be disposed adjacent to the edge of the upper surface of the housing.

The plurality of gas inducing holes may be formed in the upper frame of the bus bar frame.

The plurality of gas inducing holes may be arranged to form a plurality of columns along the length direction of the upper surface of the battery cell stack.

At least one of a plurality of columns may be disposed adjacent to the edge of the upper frame of the bus bar frame.

The plurality of gas inducing hole may be formed in the end plate.

The plurality of gas inducing hole may be formed on only one side of a pair of end plates.

The plurality of gas inducing hole may include at least three holes disposed in a line in the central portion in the height direction of each of the pair of end plates.

A battery pack according to another embodiment of the present invention may include at least one or more of the above-described battery modules.

According to embodiments of the present invention, by inducing the gas flow generated during ignition inside the battery module through the plurality of gas inducing holes in a specific direction, and observing such a gas flow through the plurality of gas inducing holes, an appropriate solution to delay ignition inside the battery module may be provided.

### BRIEF DESCRIPTION OF THE DRAWINGS

FIG. 1 is an illustration of a conventional battery module.

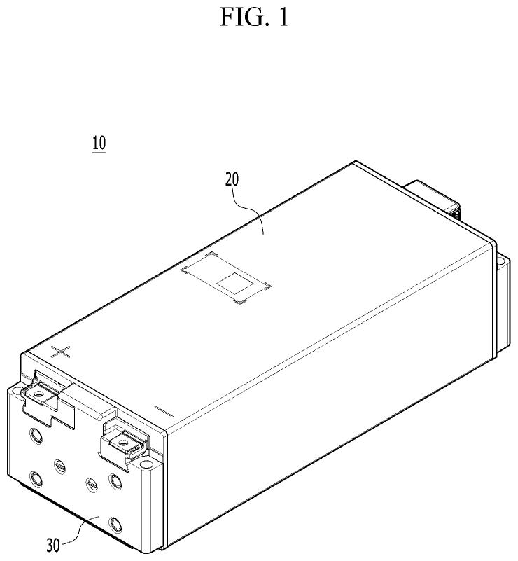

FIG. 2 is an exploded perspective view of a battery module according to an embodiment of the present invention.

FIG. 3 is a perspective view of a battery module according to another embodiment of the present invention.

FIG. 4 is a top view of the battery module of FIG. 3.

FIG. 5 is a perspective view of a battery module according to another embodiment of the present invention.

### DETAILED DESCRIPTION

The present invention will be described more fully hereinafter with reference to the accompanying drawings, in which embodiments of the invention are shown. As those skilled in the art would realize, the described embodiments may be modified in various different ways, all without departing from the spirit or scope of the present invention.

Descriptions of parts not related to the present invention are omitted, and like reference numerals designate like elements throughout the specification.

Further, since sizes and thicknesses of constituent members shown in the accompanying drawings are arbitrarily given for better understanding and ease of description, the present invention is not limited to the illustrated sizes and thicknesses. In the drawings, the thickness of layers, films, panels, regions, etc., are exaggerated for clarity. In the drawings, for better understanding and ease of description, the thicknesses of some layers and areas are exaggerated.

It will be understood that when an element such as a layer, film, region, or substrate is referred to as being “on” another element, it can be directly on the other element or intervening elements may also be present. In contrast, when an element is referred to as being “directly on” another element, there are no intervening elements present. Further, in the specification, the word “on” or “above” means positioned on or below the object portion, and does not necessarily mean positioned on the upper side of the object portion based on a gravitational direction.

In addition, unless explicitly described to the contrary, the word “comprise”, and variations such as “comprises” or “comprising”, will be understood to imply the inclusion of stated elements but not the exclusion of any other elements.

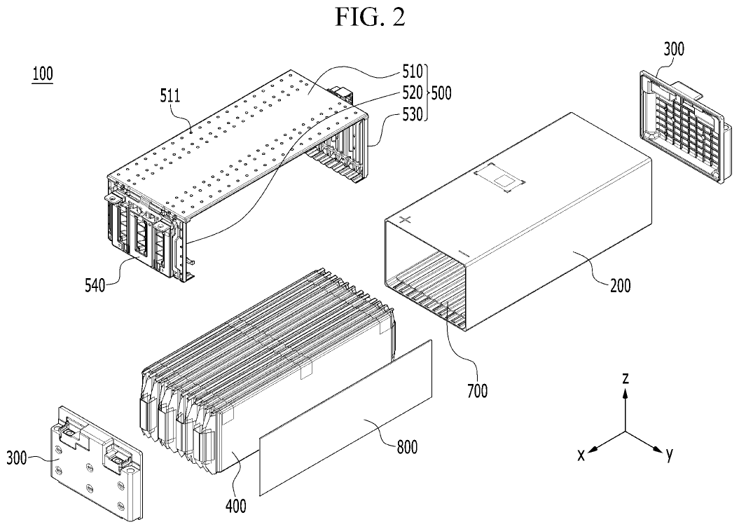

FIG. 2 is an exploded perspective view of a battery module according to an embodiment of the present invention.

As illustrated in FIG. 2, a battery module 100 according to an embodiment of the present invention includes a battery cell stack 400 including at least one battery cell, a housing 200 for accommodating the battery cell stack 400, and a thermal conductive resin layer 700 positioned between the lower part of the battery cell stack 400 and the housing 200.

The housing 200 has open front and back surfaces, and a pair of end plates 300 covering the front and back surfaces may be provided. That is, in FIG. 2, both ends in the X-axis direction are open, and a pair of end plates 300 is formed to cover the corresponding ends. In FIG. 2, the housing 200 is shown to have an integral shape with a square tube shape, but it is not limited thereto, and it may have a shape in which the upper plate is combined with a U-shaped frame having a bottom surface and a pair of side walls, or a shape in which the lower plate is combined with an inverted U-shaped frame with the upper surface and a pair of side walls.

In addition, a bus bar frame 500 accommodated in the housing 200 together with the battery cell stack 400 may be provided. The bus bar frame 500 may include an upper frame 510 positioned on an upper part of the battery cell stack 400, a front frame 520 positioned on the front of the battery cell stack 400 and a rear frame 530 positioned on the rear of the battery cell stack 400, and the bus bar 540 connected to electrode leads of the battery cells constituting the battery cell stack 400 may be mounted on the front frame 520 and the rear frame 530. In the present embodiment, a plurality of gas inducing holes 511 are formed in the upper frame 510.

A plurality of gas inducing holes 511 may be disposed to form a plurality of columns along the length direction of the battery cell stack 400, that is, the X-axis direction in FIG. 2. At least one of a plurality of columns may be disposed adjacent to one edge of the upper frame 510. That is, in FIG. 2, it may be disposed adjacent to both edges in the Y-axis direction.

As such gas inducing holes 511 are formed in the upper frame 510 of the bus bar frame 500, when ignition occurs in the battery cell stack 400, the flow of the gas generated by the ignition is guided to the upper side, and then it is possible to prevent the propagation of the ignition to other modules adjacent to the module where the ignition occurred. In addition, it is possible to visually measure the flow of gas induced to the upper part of the bus bar frame 500, and through this, it is possible to propose a solution that may induce an ignition delay in the module. Particularly, by disposing the plurality of gas inducing holes 511 to form the column along the length direction of the battery cell stack 400, it is possible to induce the gas generated from the battery cell over the entire region of the length direction.

The plurality of gas inducing holes 511 may be formed by applying a punching process to the upper frame 510. The punching method is not particularly limited, and methods such as drilling, punching, pressing, etc. may be applied.

The thermal conductive resin layer 700 is formed by injecting a thermal conductive resin onto the battery cell stack 400, and may include a thermal conductive adhesive material. Specifically, the thermal conductive resin layer 700 may be formed by injecting a thermal conductive resin having fluidity onto the battery cell stack 400, and then solidifying the thermal conductive resin in contact with the battery cell stack 400. That is, it may serve to transfer heat generated from the battery cell stack 400 to the bottom of the battery module 100 and to fix the battery cell stack 400 within the battery module 100. In addition, a heat dissipating plate 800 may be provided on a side of the battery cell stack 400 and the two can be accommodated in the housing 200 together.

According to an embodiment of the present invention, when the battery cell inside the module ignites, the gas flow is guided to the upper surface by a plurality of gas inducing holes 511 provided in the upper frame 510 of the bus bar frame 500 to prevent the ignition from propagating to other adjacent modules, and it is possible to provide an appropriate solution for the ignition delay by observing the gas flow.

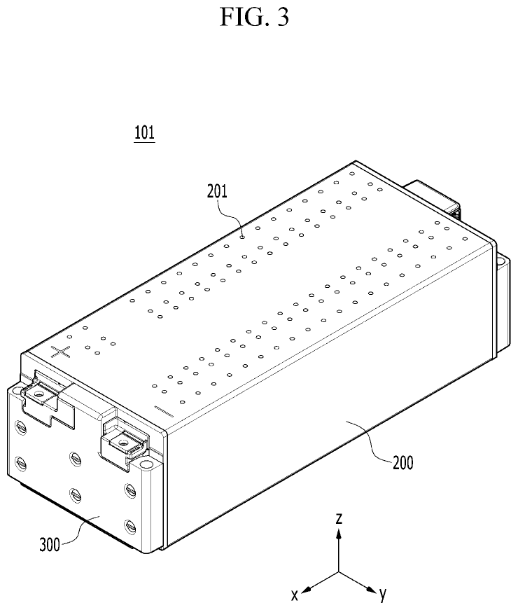

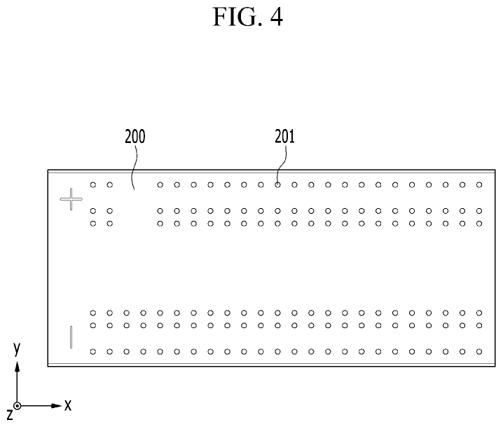

Next, the battery module according to another embodiment of the present invention is described with reference to FIG. 3 and FIG. 4.

FIG. 3 is a perspective view of a battery module according to another embodiment of the present invention. FIG. 4 is a top view of the battery module of FIG. 3.

As illustrated in FIG. 3 and FIG. 4, the battery module 101 according to another embodiment of the present invention includes a plurality of gas inducing holes 201 on the upper surface of the housing 200. Other than that, the configuration is the same as the above-described embodiment, and any common description is omitted.

A plurality of gas inducing holes 201 may be disposed to form a plurality of columns along the length direction of the battery cell stack 400, that is, the X-axis direction in FIG. 3 and FIG. 4. At least one of the plurality of columns may be disposed adjacent to one edge of the upper surface of the housing 200. That is, in FIG. 4, the plurality of columns may be disposed adjacent to both edges in the Y-axis direction.

As such gas inducing holes 201 are formed in the upper surface of the housing 200, the flow of the gas generated when ignition occurs in the battery cell stack 400 is guided to the upper side, and \it is possible to prevent the propagation of the ignition to other modules adjacent to the module where the ignition occurred. In addition, it is possible to visually measure the flow of gas induced to the upper part of the housing 200, and through this, it is possible to propose a solution that may induce an ignition delay in the module. Particularly, it is possible to induce the gas generated from the battery cell to move along the length direction by disposing the gas inducing holes 201 to form the column along the length direction of the battery cell stack 400.

In addition, in this embodiment, it has been described that a plurality of gas inducing holes 201 are included in the upper surface of the housing 200, but it is not limited thereto, and in combination with the previous embodiment, it is also possible to form the gas inducing holes 201 and 511 in the upper frame 510 of the bus bar frame 500 and the upper surface of the housing 200.

The plurality of gas inducing holes 201 may be formed by applying a punching process to the upper surface of the housing 200, and the punching method is not particularly limited, and methods such as drilling, punching, pressing, etc. may be applied.

As such, according to another embodiment of the present invention, when the battery cell inside the module ignites, the gas flow is guided to the upper surface by a plurality of gas inducing holes 201 provided in the upper surface of the housing 200 to prevent the ignition from propagating to other adjacent modules, and it is possible to provide an appropriate solution for the ignition delay by observing the gas flow.

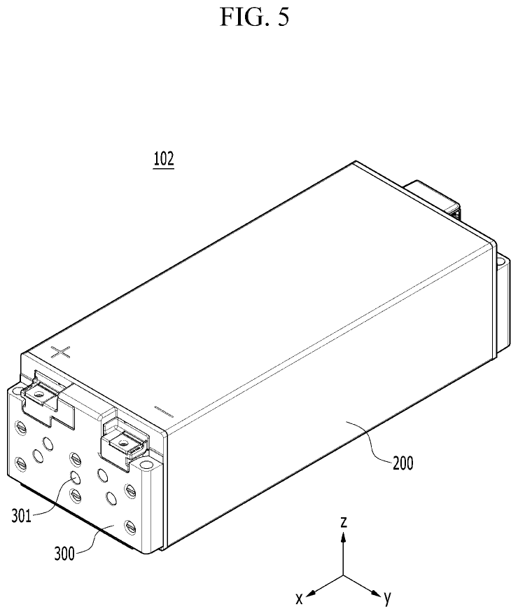

Next, the battery module according to another embodiment of the present invention is described with reference to FIG. 5.

FIG. 5 is a perspective view of a battery module according to another embodiment of the present invention.

As illustrated in FIG. 5, the battery module 102 according to another embodiment of present invention includes a plurality of gas inducing holes 301 in the end plate 300. Other than that, the configuration is the same as that of the above-described embodiment, and any common description is omitted.

A plurality of gas inducing holes 301 may be formed on either side of a pair of end plates 300. For example, it may be formed on the end plate 300 of the rear side of the battery module 102. Here, the rear surface may refer to a surface that is not adjacent to another battery module 102 when a plurality of battery modules 102 are assembled to form a battery pack, but is not limited thereto. The plurality of gas inducing holes 301, as shown in FIG. 5, may include at least three holes disposed in a line in the central portion of the height direction of the end plate 300 (i.e., the Z-axis direction of FIG. 5). However, it is not limited thereto, as shown in FIG. 5, it is possible to dispose the plurality of gas inducing holes 301 by properly distributing the plurality of holds 301 to the entire area of the end plate 300.

As such gas inducing holes 201 are formed in the end plate 300, the flow of the gas generated when ignition occurs in the battery stack 400 is guided to the upper side, and then it is possible to prevent the propagation of the ignition to other modules adjacent to the module where the ignition occurred. In addition, it is possible to visually measure the flow of gas induced to the end plate 300, and through this, it is possible to propose a solution that may induce an ignition delay in the module.

In addition, in this embodiment, it has been described that a plurality of gas inducing holes 301 are included in the end plate 300, but it is not limited thereto, and in combination with the previous embodiments, it is also possible to form the gas inducing holes 201 and 511 in the upper frame 510 of the bus bar frame 500 and the upper surface of the housing 200, and then to additionally form the gas inducing holes 301 in the end plate 300. In addition, it is also possible to form the gas inducing hole on only one of the upper frame 510 of the bus bar frame 500 and the upper surface of the housing 200, and apply the gas inducing hole 301 of the end plate 300 to this.

The gas inducing holes 301 may be formed by applying a punching process to the end plate 300, and the punching method is not particularly limited, and methods such as drilling, punching, pressing, etc. may be applied.

As such, according to another embodiment of the present invention, the gas flow is guided to the upper surface through a plurality of gas inducing holes 301 provided in the end plate 300 when the battery cell inside the module ignites to prevent the ignition from propagating to other adjacent modules, and it is possible to provide an appropriate solution for the ignition delay by observing the gas flow.

One or more battery modules according to the present embodiment described above may be mounted together with various control and protection systems such as a battery management system (BMS) and a cooling system to form a battery pack.

The battery module or battery pack can be applied to various devices. In this device, it can be applied to transportation means such as electric bicycles, electric vehicles, hybrid vehicles, and the like, but is not limited thereto, and can be applied to various devices that can use secondary batteries.

While this invention has been described in connection with what is presently considered to be practical embodiments, it is to be understood that the invention is not limited to the disclosed embodiments. On the contrary, it is intended to cover various modifications and equivalent arrangements included within the spirit and scope of the appended claims.

1. A battery module comprising:
a battery cell stack including at least one battery cell;
a bus bar frame covering an upper surface of the battery cell stack and a side surface of the battery cell stack, wherein a lead of the at least one battery cell protrudes from the side surface;
a housing for accommodating a coupled body comprising the battery cell stack and the bus bar frame; and
a pair of end plates coupled to surfaces at opposite ends of the housing, respectively, wherein a lead of the at least one battery cell is disposed at the surfaces at opposite ends of the housing,
wherein a plurality of gas inducing holes are formed in at least one of an upper part of the bus bar frame, an upper surface of the housing, and at least one of the pair of end plates.

2. The battery module of claim 1, wherein:
the plurality of gas inducing holes are formed in the upper surface of the housing.

3. The battery module of claim 2, wherein:
the plurality of gas inducing holes are arranged to form a plurality of columns along a length direction of the upper surface of the battery cell stack.

4. The battery module of claim 3, wherein:
at least one of a plurality of columns is disposed adjacent to an edge of the upper surface of the housing.

5. The battery module of claim 1, wherein:
the plurality of gas inducing holes are formed in the upper part of the bus bar frame.

6. The battery module of claim 5, wherein:
the plurality of gas inducing holes are arranged to form a plurality of columns along a length direction of the upper surface of the battery cell stack.

7. The battery module of claim 6, wherein:
at least one of a plurality of columns is disposed adjacent to an edge of the upper part of the bus bar frame.

8. The battery module of claim 1, wherein:
the plurality of gas inducing holes are formed in at least one of the pair of end plates.

9. The battery module of claim 8, wherein:
the plurality of gas inducing holes are formed on both of a pair of end plates.

10. The battery module of claim 9, wherein:
the plurality of gas inducing holes includes at least three holes disposed in a central portion of each of the pair of end plates and arranged in a line along a height direction of each of the pair of end plates.

11. A battery pack including at least one battery module of claim 1.
